(19) United States
(12) Patent Application Publication
(10) Pub. No.: US 2003/0229558 A1
(43) Pub. Date: Dec. 11, 2003

(54) Business evaluating system and business evaluating apparatus

(75) Inventors: Yasuhiro Kobayashi, Hitachinaka (JP); Yuichi Ikeda, Mito (JP); Osamu Kubo, Hitachi (JP); Takeshi Yokota, Hitachi (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/315,550

(22) Filed: Dec. 10, 2002

(30) Foreign Application Priority Data
Jun. 5, 2002 (JP) 2002-163859

(51) Int. Cl. G06F 17/60

(52) U.S. Cl. 705/36; 705/35

(57) ABSTRACT

A business evaluating system and business evaluating apparatus are provided which is capable of enhancing the efficiency of probability-based business evaluation operating processing and of assisting to proceed a plan and to evaluate an effect of practicable measure. A business progress change criterion is configured with a premise part and a conclusive part. The premise part is to specify which event is fixed among a plurality of events that any one is to occur in the schedule due to business uncertainty. The conclusive part is to designate business cancellation, enlargement, scale-down, postponement, change of contents or the like as a management measure assumed at a time point of planning, describing an effect on the subsequent schedule.

### BACKGROUND OF THE INVENTION

1. Field of the Invention

The present invention relates to a business evaluating system and business evaluating apparatus for calculating, upon projecting a business plan, a business value of the business with using, as input data, the business prospect data on the funds (investment) required in pursuing the business and an income (profit) to be obtained by the business.

2. Description of Related Art

It has already been put into a practice, in the field of corporate finance, to make a business evaluation on a business to be pursued in the future or business being currently pursued. As for a discount cash flow method, there is description, for example, in “Practical Corporate Finance” PP.12-22 by Fumio Takahashi, issued by Diamond-sha, May 31, 2001. Also, there is description, in JP-A-125962/2001, concerning a business plan simulation in line with a management target.

### SUMMARY OF THE INVENTION

In the conventional business evaluating system, there is no especial problem in pursuing a business according to a schedule once projected and given as input data (hereinafter, the schedule given as the input data is referred to as a basic scenario). However, in the case of changing a once-set business schedule (in making a business cancellation, enlargement, scale-down, postponement, content change or the like) during the process, there has been a need to prepare another schedule matched to a content of schedule change (business cancellation, enlargement, scale-down, postponement, content change or the like).

In pursuing a business, there is a case that a consideration is sought on an alternative plan of a schedule itself due to a management measure in business progress, instead of simply calculating a business value on a given schedule. In such a case, an alternative schedule is schemed reflecting a management measure in a basic scenario to evaluate an alternative-plan-based business thereby adopting a business plan high in evaluation. In order to evaluate a plurality of alternative plans, there is a need to scheme an alternative scenario by using the business prospect data in which a plan change corresponding to a different management measure is added to a basic scenario to repeat business-value calculation a plurality of number of times. Consequently, because generally the procedure of probability-based business evaluation is greater in computation amount as compared to the procedure of fixing business evaluation, there has been a problem in computation processing efficiency.

It is an advantage of the present invention to provide a business evaluating system and business evaluating apparatus capable of enhancing the efficiency of probability-based business evaluation operating processing and of assisting to proceed a plan and to evaluate an effect of practicable measure.

The Invention is, a business evaluating system for evaluating, upon projecting a business plan, a business value depending on a prospect of an investment required in proceeding the business and a profit to be obtained from the business by using an electronic computer, comprising:

a schedule for branch-displaying a plurality of events to be assumed at a time point of planning; and

a business progress change criterion for setting a criterion to change a progress of the business relying on event branching in the schedule.

With this structure, the invention can achieve the efficiency improvement in operation processing of probability-based business evaluation and assist for proceeding a plan and evaluating an effect of a practicable measure.

The invention is, a business evaluating system for evaluating, upon projecting a business plan, a business value depending on a prospect of an investment required in proceeding the business and a profit to be obtained from the business by using an electronic computer, comprising:

a schedule for branch-displaying a plurality of events to be assumed at a time point of planning; and

a business progress change criterion for setting a criterion to change a progress of the business relying on event branching in the schedule; whereby the schedule and the business progress change criterion can be selectively displayed on a display of the electronic computer.

With this structure, the invention of can achieve the promotion of efficiency in operation processing of probability-based business evaluation and assist in proceeding a plan and evaluating an effect of a practicable measure, thereby making it possible to visually confirming the matter being inputted.

The invention sets a criterion concerning a possibility of causing an event for the event branching included in the schedule.

With this structure, the invention of can achieve the promotion of efficiency in operation processing of probability-based business evaluation and assist in proceeding a plan and evaluating an effect of a practicable measure.

The invention sets a criterion concerning a possibility of causing an event for the event branching included in the schedule, the criterion concerning a possibility being to be displayed on a display of the electronic computer.

With this structure, the invention can achieve the promotion of efficiency in operation processing of probability-based business evaluation and assist in proceeding a plan and evaluating an effect of a practicable measure, thereby making it possible to visually confirming the criterion concerning a possibility.

The invention combines the inputted first schedule and the business progress change criterion to generate a new second schedule, a probability distribution of business value being calculated by providing an occurring probability to each event to be caused by event branching in the second schedule.

With this structure, the invention can achieve the promotion of efficiency in operation processing of probability-based business evaluation and assist in proceeding a plan and evaluating an effect of a practicable measure.

The invention combines the inputted first schedule and the business progress change criterion to generate a new second schedule, the generated second schedule being to be displayed on a display of the electronic computer.

With this structure, the invention can achieve the promotion of efficiency in operation processing of probability-based business evaluation and assist in proceeding a plan and evaluating an effect of a practicable measure, thereby making it possible to visually confirm a generated second schedule.

The invention combines the inputted first schedule and the business progress change criterion to generate a new second schedule, a probability distribution of business value being calculated by providing an occurring probability to each event to be caused by event branching in the second schedule, the calculated probability distribution of business value being to be displayed on a display of the electronic computer.

With this structure, the invention can achieve the efficiency improvement in operation processing of probability-based business evaluation and assist in proceeding a plan and evaluating an effect of a practicable measure, thereby making it possible to visually confirm a calculated probability distribution of business value.

The invention calculates an expected value of business value on the basis of the calculated probability distribution of business value.

With this structure, the invention can achieve the promotion of efficiency in operation processing of probability-based business evaluation and assist in proceeding a plan and evaluating an effect of a practicable measure.

The invention calculates an expected value of business value on the basis of the calculated probability distribution of business value, the calculated expected value of business value being to be displayed on a display of the electronic computer.

With this structure, the invention can achieve the promotion of efficiency in operation processing of probability-based business evaluation and assist in proceeding a plan and evaluating an effect of a practicable measure, thereby making it possible to visually confirm a calculated expected value of business value.

The invention compares a probability distribution of business value of the second schedule generated by applying the business progress change criterion with a probability distribution of business value of the inputted first schedule, to calculate a probability distribution of an effect of the business progress change criterion.

With this structure, the invention can achieve the promotion of efficiency in operation processing of probability-based business evaluation and assist in proceeding a plan and evaluating an effect of a practicable measure.

The invention compares a probability distribution of business value of the second schedule generated by applying the business progress change criterion with a probability distribution of business value of the inputted first schedule, to calculate a probability distribution of an effect of the business progress change criterion, a probability distribution of an effect of the business progress change criterion being to be displayed on a display of the electronic computer.

With this structure, the invention can achieve the promotion of efficiency in operation processing of probability-based business evaluation and assist in proceeding a plan and evaluating an effect of a practicable measure, thereby making it possible to visually confirm a calculated probability of an effect of the business progress change criterion.

The invention compares a probability distribution of business value of the second schedule generated by applying the business progress change criterion with an expected value of business value of the inputted first schedule, to calculate an expected value of an effect of the business progress change criterion.

With this structure, the invention of can achieve the promotion of efficiency in operation processing of probability-based business evaluation and assist in proceeding a plan and evaluating an effect of a practicable measure.

The invention compares a probability distribution of business value of the second schedule generated by applying the business progress change criterion with an expected value of business value of the inputted first schedule, to calculate an expected value of an effect of the business progress change criterion, the calculated expected value of an effect of the business progress change criterion being to be displayed on a display of the electronic computer.

With this structure, the invention of can achieve the promotion of efficiency in operation processing of probability-based business evaluation and assist in proceeding a plan and evaluating an effect of a practicable measure, thereby making it possible to visually confirm a calculated expected value of an effect of the business progress change criterion.

The invention determines an event occurring at event branching in the second schedule by using random numbers or pseudo random numbers and thereafter a process of operating a business value is repeated, whereby an expected value of business value being calculated according to a probability of each event at event branching.

With this structure, the invention of can achieve the promotion of efficiency in operation processing of probability-based business evaluation and assist in proceeding a plan and evaluating an effect of a practicable measure.

The invention determines an event occurring at event branching in the second schedule by using random numbers or pseudo random numbers and thereafter a process of operating a business value is repeated, whereby an expected value of business value being calculated according to a probability of each event at event branching, the calculated expected value of business value according to a probability of each event being to be displayed on a display of the electronic computer.

With this structure, the invention can achieve the promotion of efficiency in operation processing of probability-based business evaluation and assist in proceeding a plan and evaluating an effect of a practicable measure, thereby making it possible to visually confirm a calculated expected value of business value calculated according to a probability of each event.

The invention is a business evaluating apparatus for evaluating, upon projecting a business plan, a business value depending on a prospect of an investment required in proceeding the business and a profit to be obtained from the business by using an electronic computer, the electronic computer comprising:

an input device for inputting a business schedule and a business scenario control rule;

a storage device storing a business basic scenario inputted by the inputting device and a business scenario control rule, and an operation processing procedure for generating a business alternative schedule by using the business basic scenario and business scenario control rule, and calculating a business value of the alternative schedule;

an operating device for generating a business alternative schedule by using the business basic scenario and business scenario control rule stored in the storage device and calculating a business value of the alternative schedule; and

an output device for outputting the business value of the alternative schedule calculated by the operating device.

With this structure, the invention can achieve the promotion of efficiency in operation processing of probability-based business evaluation and assist in proceeding a plan and evaluating an effect of a practicable measure.

The invention is structured by providing a display for screen-displaying a business value of an alternative schedule calculated by the operating device.

With this structure, the invention can achieve the promotion of efficiency in operation processing of probability-based business evaluation and assist in proceeding a plan and evaluating an effect of a practicable measure, thereby making it possible to visually confirm a business value of alternative schedule calculated by the operating device.

### BRIEF DESCRIPTION OF THE DRAWINGS

FIG. 1 is a figure showing an embodiment of a business evaluating system according to the present invention;

FIG. 2 is a figure showing a scenario as a basis of a business shown in FIG. 1;

FIG. 3 is a figure showing a calculating procedure of business value by a discount cash flow method;

FIG. 4 is a figure represented as a variation range of cash flow on a risk assumed in a payout;

FIG. 5 is a figure showing a remaining value of a producing equipment in the basic scenario;

FIG. 6 is a figure showing a continuous probability distribution of a business risk in a relationship between a parameter representative of a business risk and a cash flow;

FIG. 7 is a figure representing the basic scenario by a binary tree;

FIG. 8 is a figure showing a table having a path of the binary tree shown in FIG. 7 and its probability;

FIG. 9 is a figure showing a discrete probability distribution shown in FIG. 8;

FIG. 10 is a figure showing one example of a business scenario control rule (business progress change criterion);

FIG. 11 is a figure showing a binary tree as an alternative plan to a schedule based on FIG. 10;

FIG. 12 is a figure showing a table having a path of the binary tree shown in FIG. 11 and its probability;

FIG. 13 is a figure showing a discrete probability distribution shown in FIG. 12;

FIG. 14 is a figure showing a tree structure having many branches;

FIG. 15 is a flowchart showing a procedure to determine a cash-flow probability distribution by a Monte Carlo Method;

FIG. 16 is a figure showing a frequency of samples a business value is fallen within a section of the business value;

FIG. 17 is a flowchart showing a procedure to evaluate an effect of the business scenario control rule (business progress change criterion); and

FIG. 18 is a figure showing an embodiment of a business evaluating apparatus according to the invention.

### DETAILED DESCRIPTION OF THE PREFERRED EMBODIMENT

An alternative plan of schedule is a modification of a basic scenario on the basis of a management measure. Provided that an alternative plan of schedule can be generated from the basic scenario, there is no need to re-input an alternative plan of schedule. In order for this, a management measure is expressed in the form of a business progress change criterion whereby an alternative plan of schedule may be generated from the basic scenario and business progress change criterion.

The present invention configures the business progress change criterion with a premise part and a conclusive part. The premise part is to specify which event is fixed among a plurality of events that any one is to occur in the schedule due to business uncertainty. The conclusive part is to designate business cancellation, enlargement, scale-down, postponement, change of contents or the like as a management measure assumed at a time point of planning, describing an effect on the subsequent schedule.

Hereunder, embodiments of the present invention will be explained using the drawings.

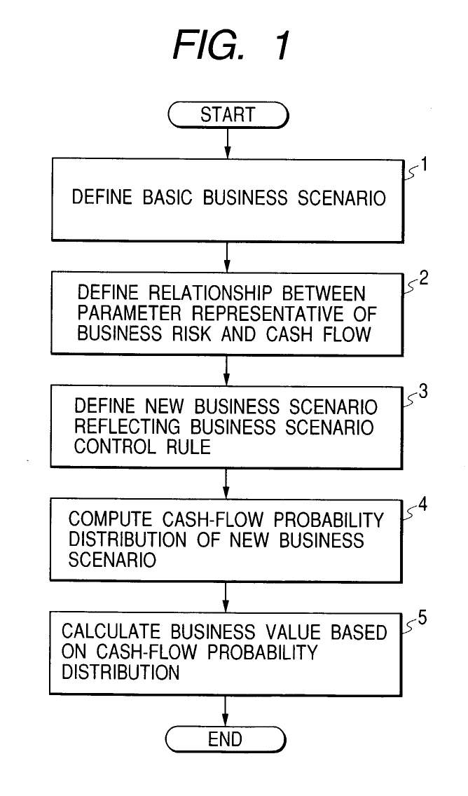

FIG. 1 shows one embodiment of a business evaluating system according to the invention. In the figure, scenario is generally such a spreadsheet software as computing a profit from a sales prospect, meaning a function to temporarily change data and simulate a result. In FIG. 1, this refers to the time series of event occurrences in a business schedule. There is shown, in FIG. 1, a procedure of business evaluation including five steps based on a scenario for implementing a business evaluating system according to the invention. The five steps comprise a definition of a business scenario as a basis in Step 1, a definition of a relationship between a parameter representative of a business risk and a cash flow in Step 2, a definition of a new business scenario reflecting a business-scenario control rule in Step 3, a computation of a cash-flow probability distribution on a new business scenario in Step 4, and calculation of business value based on a cash-flow probability distribution in Step 5.

The business evaluation procedure shown in FIG. 1 will be explained by adopting a simplified mechanical part manufacturing business as an example. Also, explanation herein will be made on a business status in a cash-flow level calculated from business financial data. Herein, cash flow means an inflow and outflow of a cash (funds) to be used in a discount cash flow method, which is an index indicative of a soundness of corporate finance. The cash flow for use in a business evaluation is calculated by adding a depreciation amount to a subtraction of a dividend and executive compensation from a post-tax profit of a settlement of account in an enterprise, referring to, what is called, a self-fund. The cash flow occurs as an investment cash flow at a time point of starting a plan of mechanical part manufacturing business. However, this occurs, during progression of the business plan, as a sum of an operating cash flow paid out by carrying out the business plan (an addition of post-tax operating profit and depreciation amount) and a investment cash flow caused by making an additional investment in proceeding the business plan (an addition of working capital demand and equipment investment).

First, in Step 1, definition is made on a basic business scenario (time series of event occurrences in a business schedule). Namely, in Step 1, definition is made on the timing of respective events in business progression of business investment, business payout, business settlement and the like, together with a definition on the accompanying cash flows.

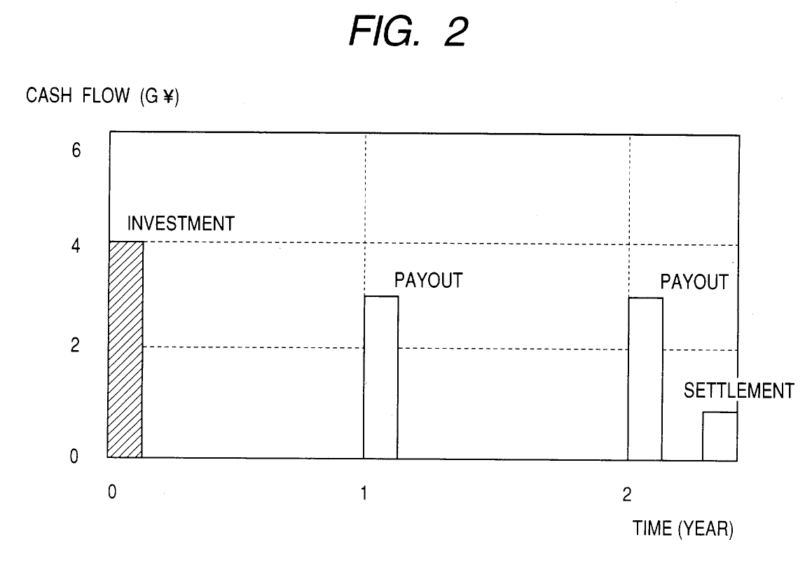

Namely, in Step 1, definition is made on a scenario as a basis of a business as shown in FIG. 2. In the basic scenario shown in FIG. 2, at first investment is made at a start of a business (e.g. 4G yen) and settled after an operation for two years. Namely, in FIG. 2, there are a constant amount (e.g. 4G yen) of cash out by an investment at a start of business, a cash in (e.g. 3G yen) due to a payout one year after, a cash in (e.g. 3G yen) due to a payout two years after, and a cash in (e.g. 1 G yen) due to a settlement. The basic scenario shown in FIG. 2 is a fixed scenario not assuming risk factors at all.

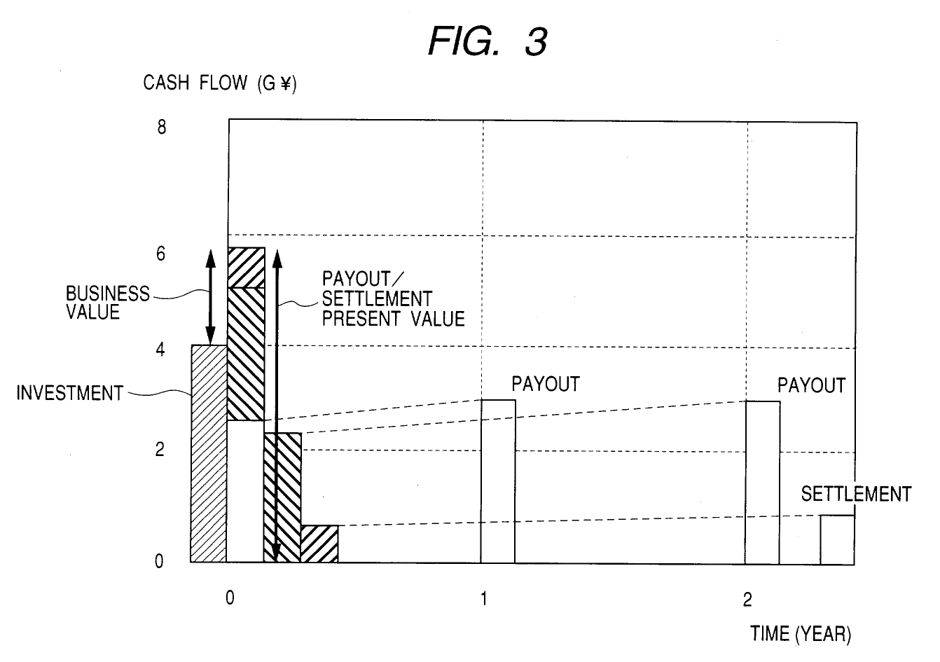

Contrary to the basic scenario of the business as shown in FIG. 2, FIG. 3 shows a calculation procedure for a business value by a discount cash-flow method. The business of FIG. 3 has a net present value.(e.g. 1.6 G yen) of a subtraction of an investment amount (e.g. 4G yen) from a present value of payout and settlement (e.g. 5.8 G yen) provided that the business start time is at present. The present value of payout and settlement (e.g. 5.8 G yen) is determined by discounting with an investment cost reflecting a business risk and financial status of from an occurrence time to the present.

Next, in Step 2, definition is made as to where risks (uncertain factors in business payout) exist in the business plan and on which cash flow what deflection is to occur by these risks. Namely, in the Step 2, definition is made on a relationship between a parameter representative of a business risk and a cash flow in a basic scenario that an investment (e.g. 4G yen) is made at a business start defined in the Step 1 and settled after an operation for two years.

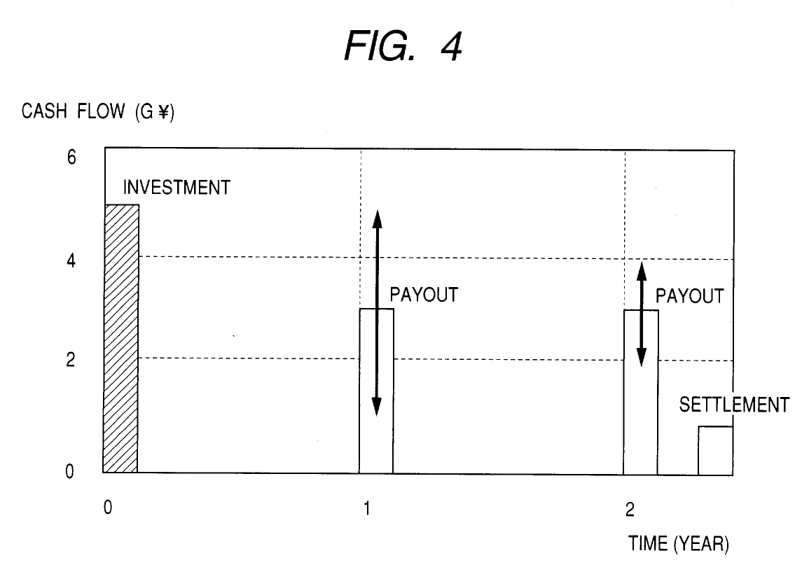

Namely, the relationship in the step 2 between a parameter representative of a business risk and a cash flow can be expressed as a variation range of a risk to be assumed in payout on a cash flow as shown in FIG. 4. The risk assumed on the basic scenario is assumed in the payouts at the first year and at the second year, corresponding to the upper and the lower of deflection respectively of 4 G yen (first year) and 2 G yen (second year). In the case of FIG. 4, the cash flow upon investment and settlement (1 G yen) is fixed.

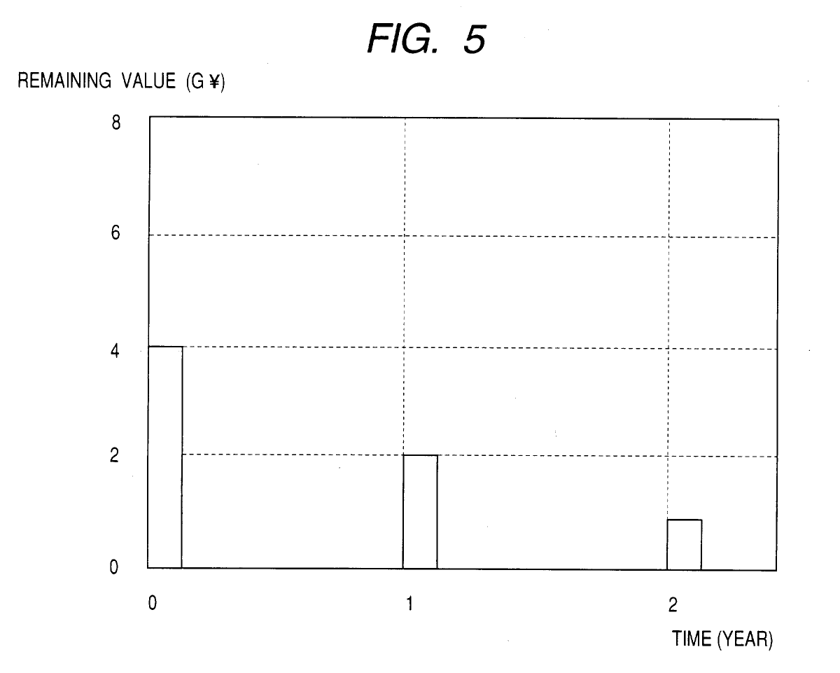

There is shown, in FIG. 5, a remaining value of a production equipment in the basic scenario an investment is made at a start of business (e.g. 4 G yen) and settled at after an operation for two years as defined in the Step 1. In FIG. 5, the remaining value of the production equipment at the business start equals to the investment amount (4 G yen). The remaining value of the production equipment in the first year is a value halved (2 G yen) of the remaining value of the production equipment at the business start. The remaining value of the production equipment in the second year is a value (1 G yen) halved of the remaining value of the production equipment in the first year (2 G yen). By a settlement at the time point of the second year, the remaining value (1 G yen) of the production equipment at the second year gives a remaining value of the production equipment at a settlement time.

Accordingly, the cash-in (1 G yen) in the settlement in FIG. 4 equals to a remaining value (1 G yen) of the production equipment upon the settlement shown in FIG. 5.

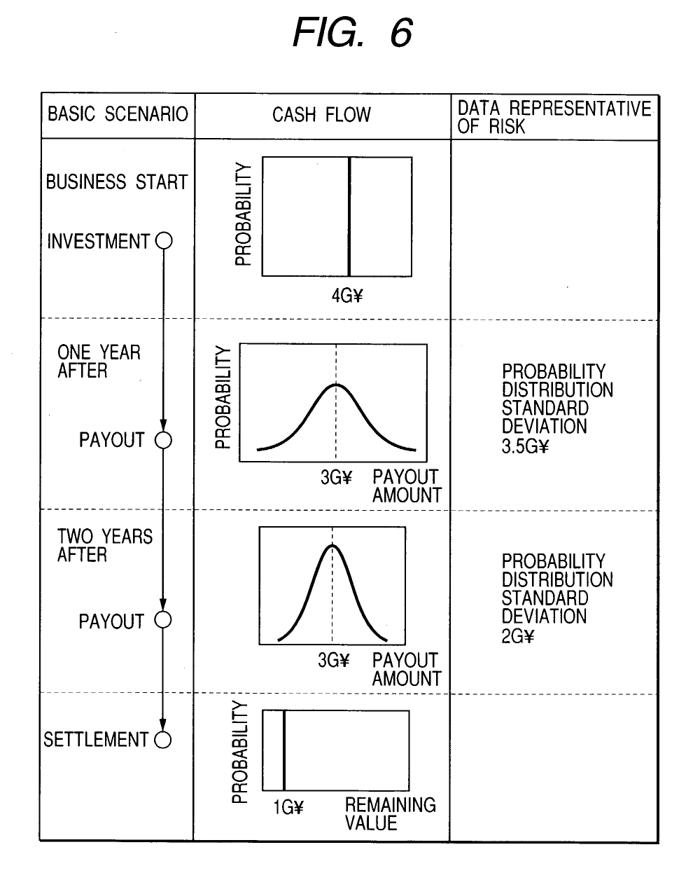

Next, there is shown, in FIG. 6, a continuous probability distribution of a business risk in the relationship between a parameter representative of a business risk and a cash flow defined in the Step 2, for the basic scenario defined in the Step 1. In FIG. 6, the deflection in cash flow is expressed as a standard deviation in normal distribution.

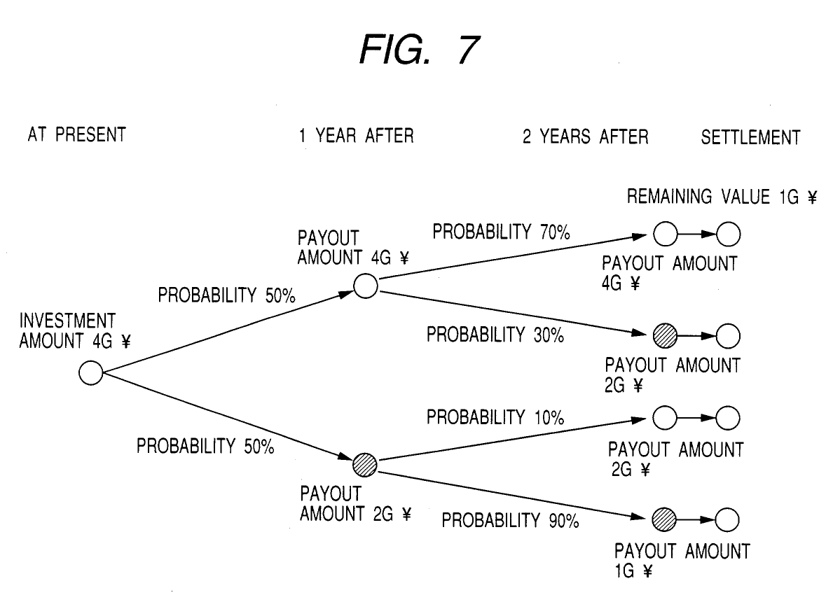

There is shown, in FIG. 7, a representation of the basic scenario defined in the Step 1 by a binary tree. In this case, the deflection in cash flow is expressed as a difference between cash-flow representative values in the binary tree branching at a certain probability.

In the binary tree shown in FIG. 7, what payout is to be expected after one year in the case of making an investment at present with an investment amount of 4 G yen (4 billion yen) results in a division with a case a payout of 4 G yen (4 billion yen) is to be expected at a probability of fifty-fifty percents and a case a payout of 2 G yen (2 billion yen) is to be expected. Furthermore, concerning what payout is to be expected, in the next year and two years after the business start, in the case a payout of 4 G yen (4 billion yen) is to be expected, a payout of 4 G yen (4 billion yen) can be expected at a probability of 70 percents. However, it is once improved but returns to the former, at a probability of 30 percents, resulting in an expectation of a payout of only 2 G yen (2 billion yen). Meanwhile, in the case of a poor payout at one year after the business start (first year), the level is difficult to maintain the next year (one year after). Meanwhile, in the case payout is poor at one year after the business start (first year), the level is also difficult to maintain the next year (one year after), wherein a probability is 10 percents in maintaining the payout in the preceding year of 2 G yen (2 billion yen) and a probability is 90 percents in still worsening, thus resulting in a payout of 1 G yen (1 billion yen). Herein, the payout expectation probability (50%, 70%, 30%, 10%, 90%, or the like) has been determined based on a future prospect and past data (actual result). Accordingly, there are shown a case as seen in the past data on an uptrend basis of economy and the case as seen in the past data on a downtrend basis thereof.

The binary tree shown in FIG. 7 includes four combinations of paths from an investment node to settlement node. Each path represents a combination of the events in business progress. Although actually one of the paths assumably takes place, the probability of which path results can be computed based on a branching probability.

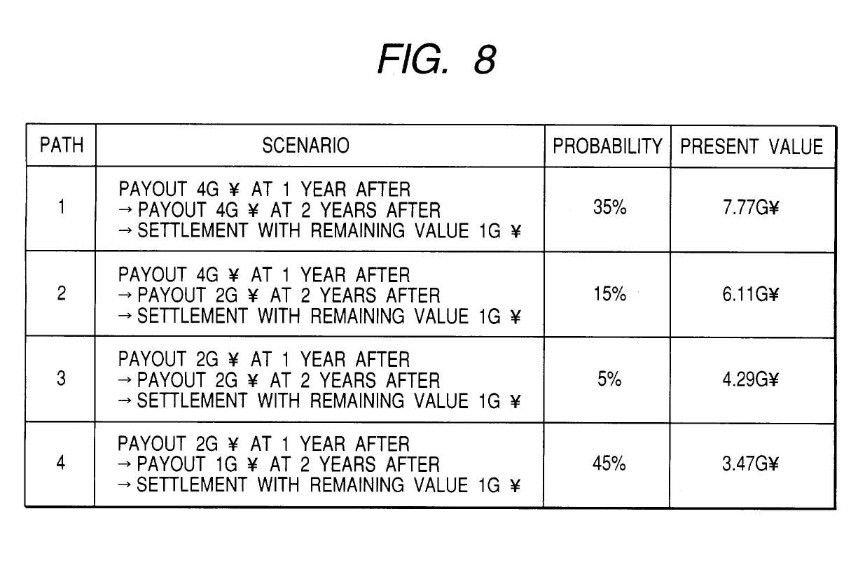

There is shown, in FIG. 8, a table having a binary tree path and its probability. In FIG. 8, for four combination of paths, it is possible to compute a probability as a product of the branching probabilities shown in FIG. 7. Incidentally, the present value of a cash flow in progress of the business shown in FIG. 8 is computed by taking an investment cost to a rate of 10% per annum.

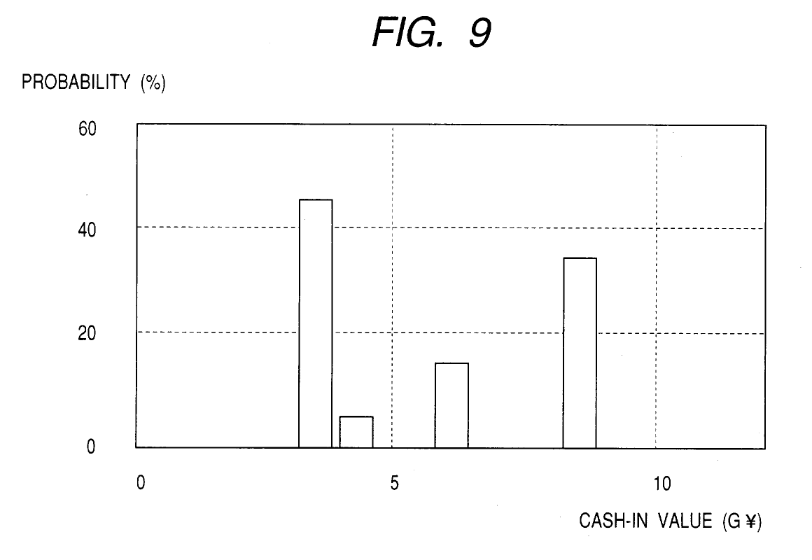

FIG. 9 shows a result of that in a discrete probability distribution. The expected value of the present value, in this case, is 5.412 G yen. The net present value, an initial investment is subtracted from that figure, is 1.412 G yen.

Incidentally, the below explanation uses a risk expression due to a binary-tree discrete probability distribution.

In Step 3, a business scenario control rule (business progress change criterion) is read to change a binary tree corresponding to the basic scenario. The subject of change concerns path addition, deletion, investment amount, payout amount and the like. There are cases premised on occurrence of a particular event.

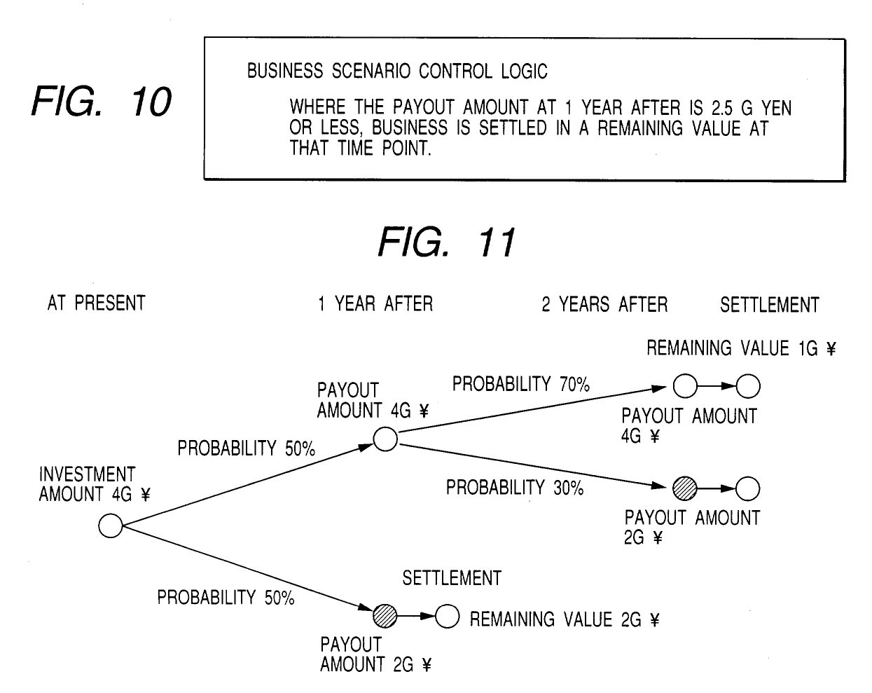

There is shown, in FIG. 10, one example of the business scenario control rule (business progress change criterion). In FIG. 10, it is under a premised condition, in this rule (change criterion), that a payout amount at after one year is 2.5 G yen or less. Because the payout amount of after one year is not fixed at a start of the business, whether the settlement time is at after one year or two years is not to be determined before lapse of one year. Consequently, it is possible to obtain an alternative plan of a schedule by combining the business scenario control logic shown in FIG. 10 and the basic scenario shown in FIG. 7.

There is shown, in FIG. 11, an alternative plan of the schedule. In FIG. 11, a branch on a case the second-year payout amount is low has been cut from the binary tree corresponding to the basic scenario defined in the Step 1. This is because a premise part of the rule (change criterion) is held for a first-year node (knot or cross-point), wherein a settlement node comes immediately following the first-year node. From FIG. 5, the remaining value is 2 G yen.

The business scenario control rule (business progress change criterion), for preparing an alternative plan of the schedule shown in FIG. 11, comprises a premise part and a conclusive part that are to be given as inputs. The premise part, representative of a condition to cause a plan change, specifies a branching node in a case of a representation with a binary tree. The conclusive part, representative of a plan change kind of cancellation, enlargement, scale-down, postponement or the like, changes a cash flow given to the subsequent binary tree structure or node depending on a plan change kind.

In the case the plan change kind is for cancellation in this business scenario control rule (business progress change criterion), a settlement node is connected to the node designated by the premise part. Also, in the case the plan change kind is for enlargement, an additional investment is made commensurate with an enlargement scale during the course, to change, matching to it, a cash flow on a node positioned downstream of that node. Furthermore, in the case the plan change kind is for scaling down, similarly changed is a cash flow on a node positioned downstream that node matchingly to a reduced scale. In the case the plan change kind is for postponement, a postponement node is connected matching to a prolonged period and a binary tree at the downstream of a node designated by the premise part is connected to a postponement node. Due to a designation by the business scenario control rule (business progress change criterion), the scenario as a basis of the business undergoes change. The post-change data of cash flow is simultaneously inputted in accordance with a time or kind of plan change.

In Step 4, a business scenario control rule (business progress change criterion) is added to determine a present value of a probability-based cash flow expected value of the business plan the basic scenario is changed. Herein, a present value of a cash-in expected value is calculated for a payout and settlement from the binary tree. Although the settlement amount is a fixed cash in itself, the timing of settlement is in a probability fashion because of a business scenario control logic.

The binary tree shown in FIG. 11 is cut of a branch in the case the second-year payout is low, by a business scenario control logic shown in FIG. 10. Accordingly, three combinations of paths are given from an investment node to settlement node.

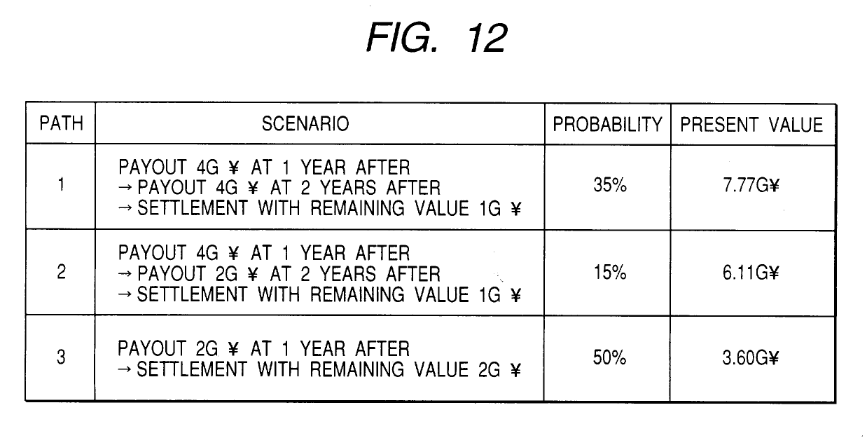

There is shown, in FIG. 12, a table having a path of the binary tree and a probability thereof. In FIG. 12, for three combinations of paths, a probability can be computed as a product of branching probabilities shown in FIG. 11. Incidentally, a present value of a cash flow due to progress of the business shown in FIG. 12 is computed by taking an capital cost as 10% per annum.

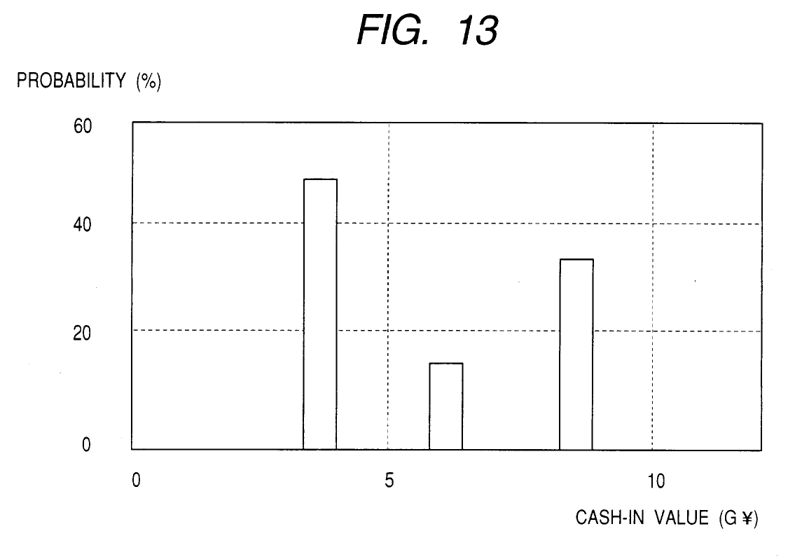

FIG. 13 represents a result of it as a discrete probability distribution. The expected value of a present value, in this case, is 5.4636 G yen. The net present value that the initial investment amount is subtracted from this figure is 1.436 G yen.

In Step 5, a net present value is calculated from a probability distribution of business cash flow. The business net present value is given by a subtraction of the initial investment from the present value of a cash-in expected value, for payout and settlement. The present value of payout and settlement is determined by discounting with a capital cost reflecting a business financial status from an occurrence time to the present. The expected value of the present value, in this case, is 5.436 G yen. The net present value that the initial investment amount is subtracted from this figure is 1.436 G yen.

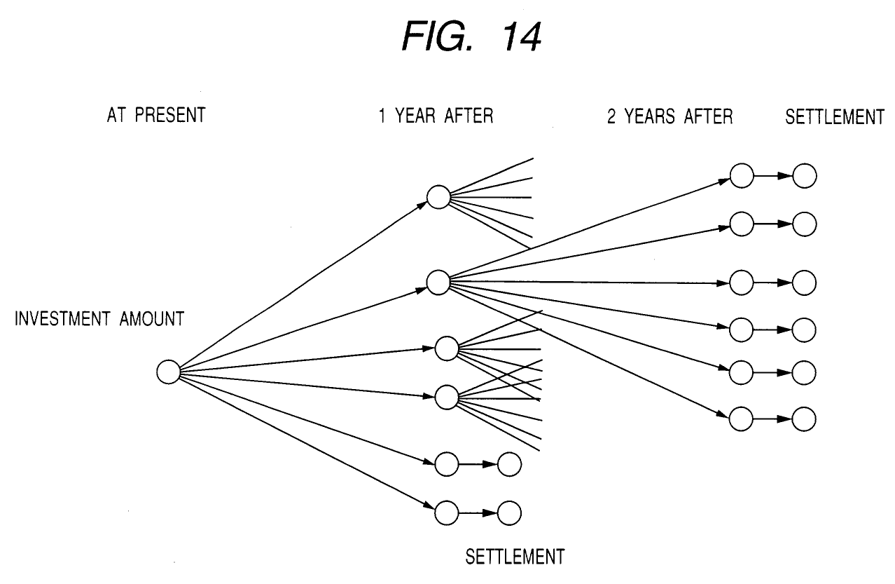

The above explanation used the example that the business scenario was represented by a binary tree wherein the change of a business plan was based on a single business scenario control rule (business progress change criterion). It is possible to use a set of business scenario control rules. Even where a business risk is expressed by a binary tree, in the case the binary three is in a complicated structure, there is troublesome in computing a cash-flow probability distribution. Even in the case a business risk is expressed by a probability distribution with continuous variables, it is also possible, in a business scenario, to approximate with a tree structure having many branches as shown in FIG. 14. However, there is troublesome in computing a cash-flow probability distribution.

In such a case, a Monte Carlo Method can be used as effective means to calculate a probability distribution. The Monte Carlo Method is a mathematical approach to determine an approximate solution to a problem by a numerical experiment with the use of repeated computations and random numbers. The Monte Carlo Method is described in “Computational Finance” (issued by Asakura Shoten).

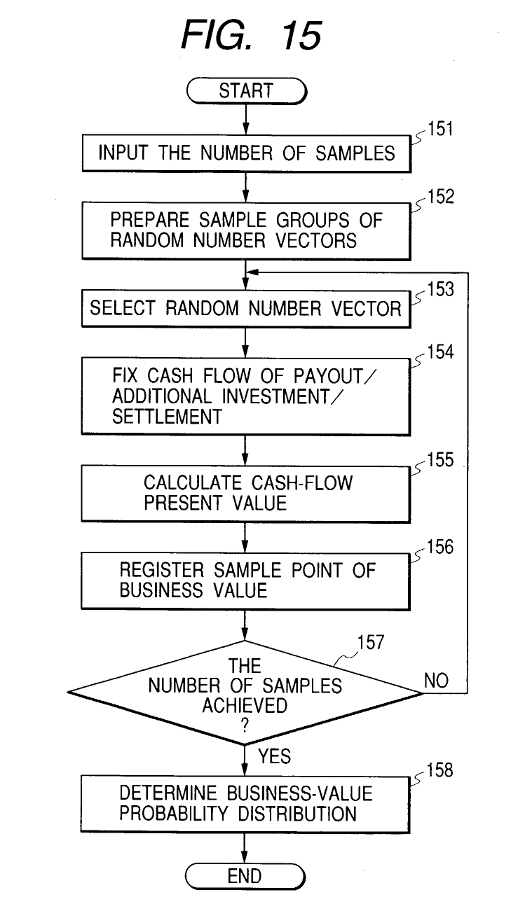

In FIG. 15, there is shown a flowchart showing a procedure for determining a cash-flow probability distribution by the Monte Carlo Method. The procedure of this flowchart is divided into a front stage for preparing a set of pseudo random numbers in a simulation trial loop and a rear stage for calculating a variable value to determine a probability distribution by using it.

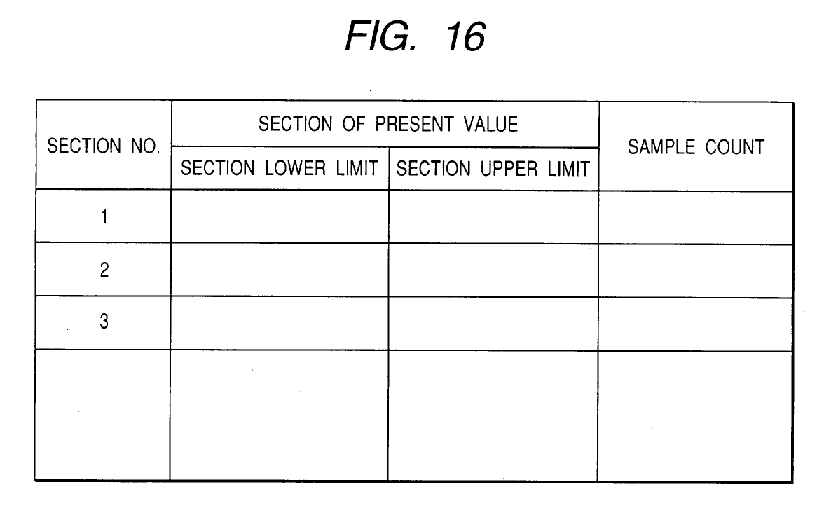

First, in Step 151, inputted is the number of samples (what number of times trial is to be done, usually ten thousands or more). In case the number of samples is inputted in the Step 151, a sample group of random number vectors is prepared in Step 152 (corresponding to the front stage). In case a sample group of random number vectors is prepared in Step 152, a random number vector is selected in Step 153. In case a random number vector is selected in Step 153, a cash flow in payout/additional investment/settlement is fixed in Step 154. In case a cash flow in payout/additional investment/settlement is fixed in Step 154, a cash-flow present value is calculated in Step 155. In case a cash-flow present value is calculated in Step 155, a sample point of business value is registered in Step 156. In case a sample point of business value is registered in Step 156, determination is made, in Step 157, whether the number of samples has been achieved or not. In case it is determined in Step 157 that the number of samples has not been achieved, the process returns to Step 153. Meanwhile, in case it is determined in Step 157 that the number of samples has been achieved, a probability distribution of business value is determined in Step 158 (corresponding to the rear stage). By thus repeating trials in the Monte Carlo Method, a sample of business value can be generated. It is possible to count a frequency of samples that a business value is fallen within a section of business value as in FIG. 16. The probability distribution of business value can be expressed by a histogram prepared by counting a sample frequency.

By collectively carrying out a business evaluation due to a basic scenario and a business evaluation due to an alternative scenario using a business scenario control rule (business progress change criterion), it is possible to quantitatively evaluate an effect of the business scenario control rule (business progress change criterion).

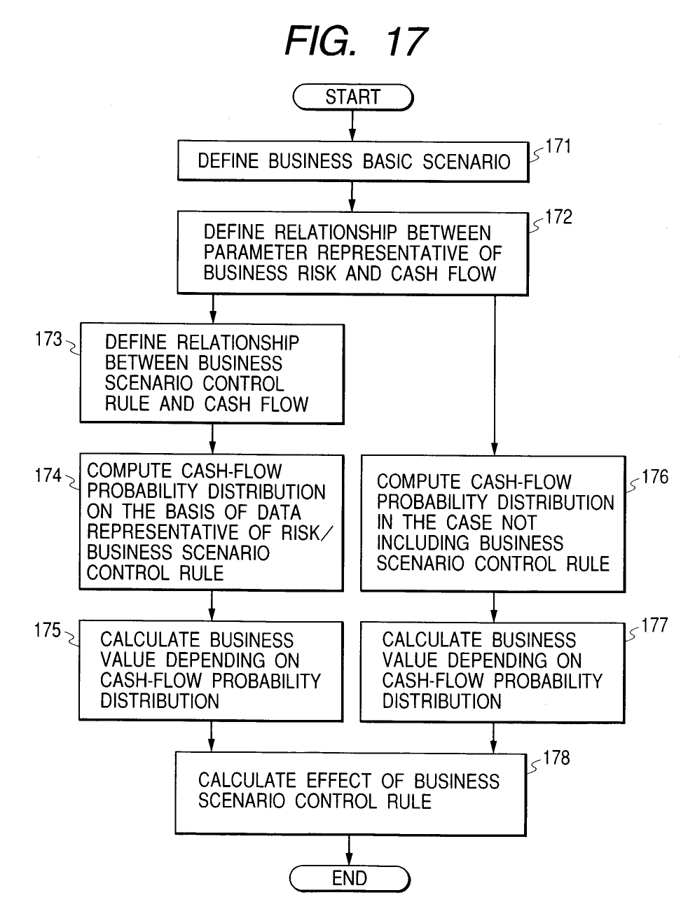

In FIG. 17, there is shown a procedure for evaluating an effect of the business scenario control rule (business progress change criterion). Namely, FIG. 17 is to simultaneously carry out a case in which a simulation is made on the former plan (business basic scenario), as it is, not including such a logic as controlling the business (business scenario control logic) and that including such a logic as controlling the business (business scenario control logic), to compute such difference-like information as whether the effect including a business scenario control logic and the effect of business scenario control rule (business progress change criterion) operate toward improvement or worsening. Namely, the effect of business scenario control rule (business progress change criterion) is determined by subtracting a basic-scenario business evaluation from an alternative scenario using a business scenario control rule (business progress change criterion). In the example of the mechanical part manufacturing business explained in the embodiment, the basic-scenario net present value is 1.412 G yen and the alternative-scenario business net present value using the business scenario control rule is 1.436 G yen. Accordingly, it can be seen that the effect of the business scenario control rule (business progress change criterion) is 0.024 G yen thus having a plus value.

By using a basic scenario and a plurality of set of business scenario control rules (business progress change criterions) to sequentially evaluate the effects of the business scenario control rules (business progress change criterions), it is possible to select a business scenario control rule (business progress change criterion) highest in business value.

The present embodiment describes a business risk, or uncertain status, in a level of cash flow by the use of a binary tree. Instead of directly inputting a cash flow, it is possible to provide a form for calculation in a system by giving detailed financial data required in cash-flow computation. In this case, the business scenario control rule can be given in a management index level to be determined from detailed financial data instead of in a cash-flow level.

Concerning a business risk, instead of directly giving a numeral of cash flow, it is possible to input a quantitative expression, such as good, usual or worse, to take a form of numeration based thereon in the system.

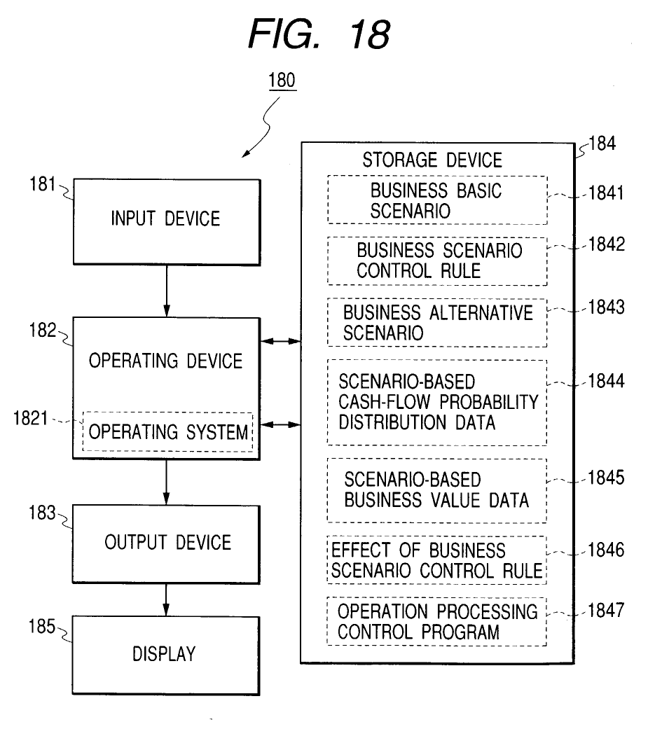

FIG. 18 shows one embodiment of a business evaluating apparatus according to the invention. In FIG. 18, a business evaluating apparatus 180 is configured with an input device 181, an operating device 182, an output device 183, a storage device 184 and a display 185.

The input device 181 reads in a business basic scenario and a business scenario control rule (business progress change criterion). Also, the storage device 184 stores a business basic scenario, a business scenario control rule (business progress change criterion) and an operation processing procedure for calculating a business value of an alternative scenario. Specifically, a business basic scenario 1841, a business scenario control rule (business progress change criterion) 1842, a business alternative scenario 1843, scenario-based cash-flow probability distribution data 1844, scenario-based business evaluation data 1845, an effect 1846 of the business scenario control rule (business progress change criterion) and an operation processing program 147.

Meanwhile, the operating device 182 generates, in a CPU, a business alternative scenario 1843 by using a business basic scenario 1841 and business scenario control rule (business progress change criterion) 1842 stored in the storage device 184, to operate for calculating a business value of the alternative scenario 1843. The operating device 182 incorporates therein an operating system 1821. Furthermore, the output device 183 is to output a calculated business value. The output device 183 is connected with a display 185.

As explained above, the present invention has the effects stated in the below.

According to the invention, it is possible to achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm the matter being inputted.

According to the invention, it is possible to achieve the promotion of efficiency in operation processing of probability-based business evaluation and assist for proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm the criterion concerning a possibility.

According to the invention, it is possible to achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm a generated second schedule.

According to the invention, it is possible to achieve the promotion of efficiency in operation processing of probability-based business evaluation and assist in proceeding a plan and evaluating an effect of a practicable measure, thereby making it possible to visually confirm a calculated probability distribution of business value.

According to the invention, it is possible to achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm an expected value of business value.

According to the invention, it is possible to achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm a calculated probability of an effect of the business progress change criterion.

According to the invention, it is possible to achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm a calculated expected value of an effect of the business progress change criterion.

The invention can achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm a expected value of business value calculated according to a probability of each event.

According to the invention, it is possible to achieve the promotion of efficiency in operation processing of probability-based business evaluation and assist in proceeding a plan and evaluating an effect of a practicable measure.

According to the invention, it is possible to achieve the promotion of efficiency in operation processing of probability-based business evaluation and assist in proceeding a plan and evaluating an effect of a practicable measure, thereby making it possible to visually confirm a business value of an alternative schedule calculated by the operating device.

What is claimed is:

1. A business evaluating system for evaluating, upon projecting a business plan, a business value depending on a prospect of an investment required in proceeding the business and a profit to be obtained from the business by using an electronic computer, comprising:
a schedule for branch-displaying a plurality of events to be assumed at a time point of planning; and
a business progress change criterion for setting a criterion to change a progress of the business relying on event branching in the schedule.

2. A business evaluating system for evaluating, upon projecting a business plan, a business value depending on a prospect of an investment required in proceeding the business and a profit to be obtained from the business by using an electronic computer, comprising:
a schedule for branch-displaying a plurality of events to be assumed at a time point of planning; and
a business progress change criterion for setting a criterion to change a progress of the business relying on event branching in the schedule;
wherein the schedule and the business progress change criterion can be selectively displayed on a display of the electronic computer.

3. A business evaluating system according to claim 1, wherein a criterion concerning a possibility of causing an event is set for the event branching included in the schedule.

4. A business evaluating system according to claim 1, wherein a criterion concerning a possibility of causing an event is set for the event branching included in the schedule, the criterion concerning the possibility being to be displayed on a display of the electronic computer.

5. A business evaluating system according to claim 1, wherein the inputted first schedule and the business progress change criterion are combined to generate a new second schedule, a probability distribution of business value being calculated by providing an occurring probability to each event to be caused by event branching in the second schedule.

6. A business evaluating system according to claim 1, wherein the inputted first schedule and the business progress change criterion are combined to generate a new second schedule, the generated second schedule being to be displayed on a display of the electronic computer.

7. A business evaluating system according to claim 1, wherein the inputted first schedule and the business progress change criterion are combined to generate a new second schedule, a probability distribution of business value being calculated by providing an occurring probability to each event to be caused by event branching in the second schedule, the calculated probability distribution of business value being to be displayed on a display of the electronic computer.

8. A business evaluating system according to claim 5, wherein an expected value of business value is calculated on the basis of the calculated probability distribution of business value.

9. A business evaluating system according to claim 5, wherein an expected value of business value is calculated on the basis of the calculated probability distribution of business value, the calculated expected value of business value being to be displayed on a display of the electronic computer.

10. A business evaluating system according to claim 5, wherein a probability distribution of business value of the second schedule generated by applying the business progress change criterion is compared with a probability distribution of business value of the inputted first schedule, to calculate a probability distribution of an effect of the business progress change criterion.

11. A business evaluating system according to claim 5, wherein a probability distribution of business value of the second schedule generated by applying the business progress change criterion is compared with a probability distribution of business value of the inputted first schedule, to calculate a probability distribution of an effect of the business progress change criterion, the calculated probability distribution of an effect of the business progress change criterion being to be displayed on a display of the electronic computer.

12. A business evaluating system according to claim 8, wherein a probability distribution of business value of the second schedule generated by applying the business progress change criterion is compared with an expected value of business value of the inputted first schedule, to calculate an expected value of an effect of the business progress change criterion.

13. A business evaluating system according to claim 8, wherein a probability distribution of business value of the second schedule generated by applying the business progress change criterion is compared with an expected value of business value of the inputted first schedule, to calculate an expected value of an effect of the business progress change criterion, the calculated expected value of an effect of the business progress change criterion being to be displayed on a display of the electronic computer.

14. A business evaluating system according to claim 8, wherein an event occurring at event branching in the second schedule is determined by using random numbers or pseudo random numbers and thereafter a process of operating a business value is repeated, whereby an expected value of business value being calculated according to a probability of each event at event branching.

15. A business evaluating system according to claim 8, wherein an event occurring at event branching in the second schedule is determined by using random numbers or pseudo random numbers and thereafter a process of operating a business value is repeated, whereby an expected value of business value being calculated according to a probability of each event at event branching, the calculated expected value of business value according to a probability of each event being to be displayed on a display of the electronic computer.

16. A business evaluating apparatus for evaluating, upon projecting a business plan, a business value depending on a prospect of an investment required in proceeding the business and a profit to be obtained from the business by using an electronic computer, the electronic computer comprising:
an input device for inputting a business schedule and a business scenario control rule;
a storage device storing a business basic scenario inputted by the inputting device and a business scenario control rule, to generate a business alternative schedule by using the business basic scenario and business scenario control rule, and calculate a business value of the alternative schedule;
an operating device for generating a business alternative schedule by using a business basic scenario and business scenario control rule stored in the storage device and calculating a business value of the alternative schedule; and
an output device for outputting the business value of an alternative schedule calculated by the operating device.

17. A business evaluating apparatus according to claim 16, further comprising a display for screen-displaying a business value of an alternative schedule calculated by the operating device.

18. A business evaluating system according to claim 2, wherein a criterion concerning a possibility of causing an event is set for the event branching included in the schedule.

19. A business evaluating system according to claim 2, wherein a criterion concerning a possibility of causing an event is set for the event branching included in the schedule, the criterion concerning the possibility being to be displayed on a display of the electronic computer.

20. A business evaluating system according to claim 2, wherein the inputted first schedule and the business progress change criterion are combined to generate a new second schedule, a probability distribution of business value being calculated by providing an occurring probability to each event to be caused by event branching in the second schedule.
